(19) United States
(12) Patent Application Publication
(10) Pub. No.: US 2024/0034282 A1
(43) Pub. Date: Feb. 1, 2024

(54) Temperature Controlled Applicator for Car Washes

(71) Applicant: The Cobra System LLC, West Mifflin, PA (US)

(72) Inventor: Timothy V. Taylor, Canonsburg, PA (US)

(21) Appl. No.: 18/228,294

(22) Filed: Jul. 31, 2023

Related U.S. Application Data
(60) Provisional application No. 63/393,436, filed on Jul. 29, 2022.

(51) Int. Cl. B60S 3/04

(52) U.S. Cl. CPC B60S 3/042

(57) ABSTRACT

A vehicle wheel and tire cleaning apparatus for use in an automatic car wash line, including an applicator box comprised of an outer compartment, the outer compartment defining an open space containing cleaning solution supply and connected to a cleaning solution supply piping and a flow control valve; the cleaning solution supply passing through the outer compartment; the cleaning solution supply piping having at least one spray nozzle connected thereto, wherein the cleaning solution supply piping has connected thereto a cleaning solution tank, a check valve, a bifurcated pipe and at least two spray nozzles, with an inline air diaphragm pump placed between the outer compartment and the check valve; a flow control valve inline with the cleaning solution supply piping; and the applicator box being positionable on the automatic car wash line.

### CROSS REFERENCE TO RELATED APPLICATION

This application claims priority to U.S. Provisional Application No. 63/393,436 filed Jul. 29, 2022 and hereby incorporates by references in its entirety the contents of the application.

### BACKGROUND OF THE INVENTION

### Field of the Invention

The present invention relates generally to an automatic car wash, and more specifically, to a touchless heated wheel and tire applicator system for cleaning wheels and tires attached to vehicles passing through an automatic car wash.

### Description of Related Art

The unsightly build-up of road grime, dirt, and brake dust on the wheels and tires of vehicles has been an ongoing dilemma for any vehicle owner. Accordingly, wheel and tire cleaning systems have been developed for use with automatic car washes and automatic tire washing systems. Generally, the prior art discloses wheel and tire cleaning systems which are comprised of a piping system that provides for the delivery of cleaning solution through the piping system to a cleaning solution applicator apparatus, then to the wheels and tires of a vehicle.

Common tire cleaning apparatuses often remove the protective coating on the side wall portion of a tire after the tire has been mounted on a vehicle wheel. Commonly the apparatus is used to clean the side wall of a tire mounted on a vehicle wheel prior to attachment of the tire and wheel to the vehicle. The wheel-mounted tire is placed in the apparatus, where it is exposed to a scrubbing implement, such as a brush. The scrubbing implement is attached to the end of a pipe, tube or hollow arm, which is open at its lower or distal end, to provide the means to discharge liquid between the bristles of the brush. The scrubbing implement is connected at its upper or proximal end to a hose, which is connected to an outflow pipe of a tank. The cleaning solution in the tank is heated by a heating element.

Another common system for metering a cleaning solution for vehicles includes a means for metering a cleaning solution that is applied to a vehicle wheel for cleaning purposes. The systems commonly include electric tape on the cleaning solution delivery pipes to prevent freezing of the cleaning solution as it travels from a cleaning solution reservoir to the spray nozzles via the main and branch delivery pipes. The main and branch delivery pipes are often insulated with the electric tape, all of which is enclosed in a hollow plastic tube. Alternatively, the pipes may be insulated with a heat tube that surrounds the main and branch pipes, which has disposed therein an electrical heating oil.

Various wheel and tire cleaning systems are disclosed in the prior art. However, there remains a need for a wheel and tire cleaning solution applicator that heats the cleaning solution by means of a heater at the point of application of the cleaning solution in an automatic car wash system. The present invention meets this need, and it overcomes the limitations in the prior art by eliminating tire and wheel cleaning brushes and associated power packs, and it also eliminates a heated holding tank for the water, while accurately monitoring the cleaning solution temperature.

### SUMMARY OF THE INVENTION

An embodiment of the present invention relates to a vehicle wheel and tire cleaning apparatus for use in an automatic car wash line, comprising: an applicator box comprised of an outer compartment, the outer compartment defining an open space containing cleaning solution supply and connected to a cleaning solution supply piping; the cleaning solution supply passing through the outer compartment; the cleaning solution supply piping having at least one spray nozzle connected thereto, wherein the cleaning solution supply piping has connected thereto a cleaning solution tank, a check valve, a bifurcated pipe and at least two spray nozzles, with an inline air diaphragm pump placed between the outer compartment and the check valve; and the applicator box being positionable on the automatic car wash line.

Another embodiment of the present invention may further comprise a hot water tank connected thereto a hot water inflow pipe with an inline water pump, and a water outflow pipe, with a hot water source connected in circuit with the inflow pipe and the outflow pipe.

Another embodiment of the present invention may further comprise at least a portion of the cleaning solution, just upstream of the at least one spray nozzle, passes between the inner tube and outer tube.

Another embodiment of the present invention may further comprise a triggering mechanism for opening and closing the check valve.

Another embodiment of the present invention may further comprise the check valve configured to cause fluid to travel in one direction.

Another embodiment of the present invention may further comprise the at least two spray nozzles are located at the top of the applicator box.

Another embodiment of the present invention may further comprise: an applicator box; a mixing system comprised of: a hot water source, piping, a pump and a mixing tank; and at least one spray nozzle, a solenoid valve with triggering device, a diaphragm pump, and cleaning solution source; at least one distal end of the piping in the mixing system being positioned in the mixing tank; and a temperature sensor located between the outer tube and the inner tube and arranged to extend parallel with a heater; wherein the applicator box defines the mixing tank, and the applicator box is positioned adjacent to the spray nozzles, on the automatic car wash line.

Another embodiment of the present invention may further comprise the mixing tank connected thereto a hot water inflow pipe with an inline water pump, and a water outflow pipe, with a hot water source connected in circuit with the inflow pipe and the outflow pipe.

Another embodiment of the present invention may further comprise the temperature sensor arranged to extend from a heating element plate.

Another embodiment of the present invention may further comprise a portion of the cleaning solution supply piping, just upstream of the at least one spray nozzle, fluidly connected to the mixing tank.

Another embodiment of the present invention may further comprise a triggering mechanism for opening and closing the check valve.

Another embodiment of the present invention may further comprise the check valve configured to cause fluid to travel in one direction.

Another embodiment of the present invention may further comprise a remote temperature controller.

Another embodiment of the present invention may further comprise a vehicle wheel and tire cleaning apparatus for use in an automatic car wash line, comprising: an applicator box comprised of an cleaning solution compartment, the cleaning solution compartment defining an open space containing cleaning solution supply and fluidly connected to a cleaning solution supply piping and a flow control valve and at least one spray nozzle; a cleaning solution supply passing through the fluidly connected cleaning solution compartment, the cleaning solution supply piping, and the flow control valve; and a heating element.

Another embodiment of the present invention may further comprise the applicator box being positionable on the automatic car wash line.

Another embodiment of the present invention may further comprise a pressure relief valve fluidly connected to a heat exchange compartment.

Another embodiment of the present invention may further comprise a temperature sensor arranged to extend from a heating element plate parallel with the heating element and located within the cleaning solution compartment and in proximity to the heat exchange compartment.

Another embodiment of the present invention may further comprise a triggering mechanism for opening and closing the flow control valve.

Another embodiment of the present invention may further comprise a remote temperature controller.

Another embodiment of the present invention may comprise a temperature sensor located between the outer tube and the inner tube and arranged to extend parallel with a heater from a heating element plate.

Another embodiment of the present invention may include a portion of the cleaning solution supply piping, just upstream of the at least one spray nozzle, passing through the hot water tank.

Another embodiment of the present invention may comprise a triggering mechanism for opening and closing the flow control valve.

Another embodiment of the present invention may include the check valve configured to cause fluid to travel in one direction and reduce unwanted debris from entering the system.

Another embodiment of the present invention may comprise a remote temperature controller.

Another embodiment of the present invention may comprise an applicator box; a hot water system comprised of a hot water source, piping, a water pump and a hot water tank; and a cleaning solution supply system comprised of spray nozzles, piping, a solenoid valve with triggering device, a diaphragm pump, a cleaning solution tank, and cleaning solution; a distal end of the piping in the cleaning solution supply system being positioned in the hot water tank; and a temperature sensor located within the outer tube and arranged to extend parallel with a heater; wherein the applicator box defines the hot water tank, and the applicator box is positioned adjacent to the spray nozzles, on the automatic car wash line.

Another embodiment of the present invention may include the hot water tank connected thereto a hot water inflow pipe with an inline water pump, and a water outflow pipe, with a hot water source connected in circuit with the inflow pipe and the outflow pipe.

Another embodiment of the present invention may include the temperature sensor arranged to extend from a heating element plate.

Another embodiment of the present invention may include a portion of the cleaning solution supply piping, just upstream of the at least one spray nozzle, passing through the hot water tank.

Another embodiment of the present invention may comprise a triggering mechanism for opening and closing the flow control valve.

Another embodiment of the present invention may include the check valve configured to cause fluid to travel in one direction and reduce unwanted debris from entering the system.

Another embodiment of the present invention may comprise a remote temperature controller.

Another embodiment of the present invention may comprise an applicator box comprised of an cleaning solution compartment and a heat exchanger, the cleaning solution compartment defining an open space containing cleaning solution supply and fluidly connected to a cleaning solution supply piping and a flow control valve and at least one spray nozzle, the at least one spray nozzle located at the top of the applicator box; a cleaning solution supply passing through the fluidly connected cleaning solution compartment, the cleaning solution supply piping, and the flow control valve; and the heat exchanger comprising a heating element.

Another embodiment of the present invention may comprise the applicator box is positionable on the automatic car wash line.

Another embodiment of the present invention may comprise the at least one spray nozzle is configured to release excess pressure.

Another embodiment of the present invention may comprise a temperature sensor arranged to extend from a heating element plate parallel with the heating element.

Another embodiment of the present invention may comprise a triggering mechanism for opening and closing the flow control valve.

Another embodiment of the present invention may comprise a remote temperature controller.

Another embodiment of the present invention may comprise the temperature sensor is located within the cleaning solution compartment and in proximity to the heat exchanger.

### BRIEF DESCRIPTION OF THE DRAWINGS

FIG. 1 illustrates a perspective view of the apparatus according to the present invention;

FIG. 2 illustrates a side view of the apparatus according to the present invention;

FIG. 3 illustrates a side view cutaway of the apparatus according to the present invention;

FIG. 4 illustrates an exploded view of the apparatus according to the present invention;

FIG. 5 illustrates a front view of the apparatus according to the present invention;

FIG. 6 illustrates a side view of the apparatus according to the present invention; and

FIG. 7 illustrates a front view of an alternative embodiment of the apparatus according to the present invention.

### DESCRIPTION OF THE INVENTION

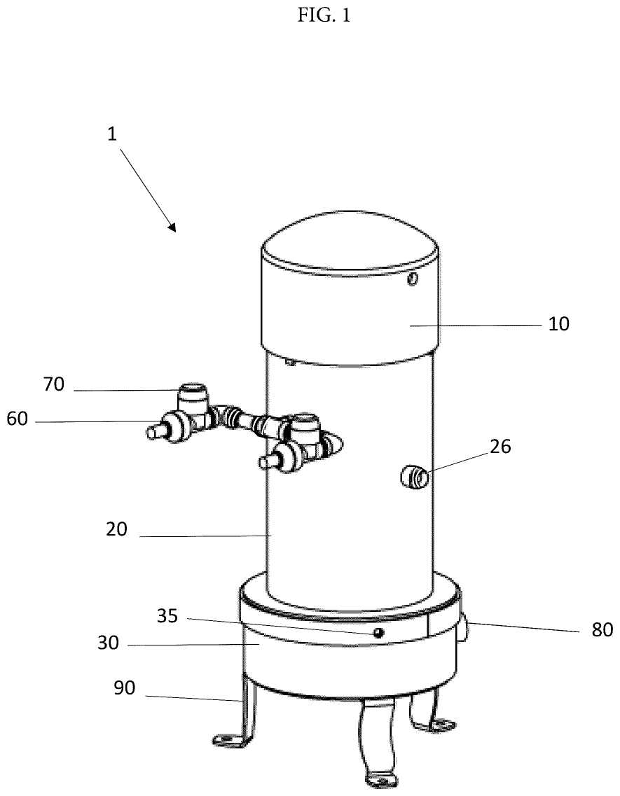

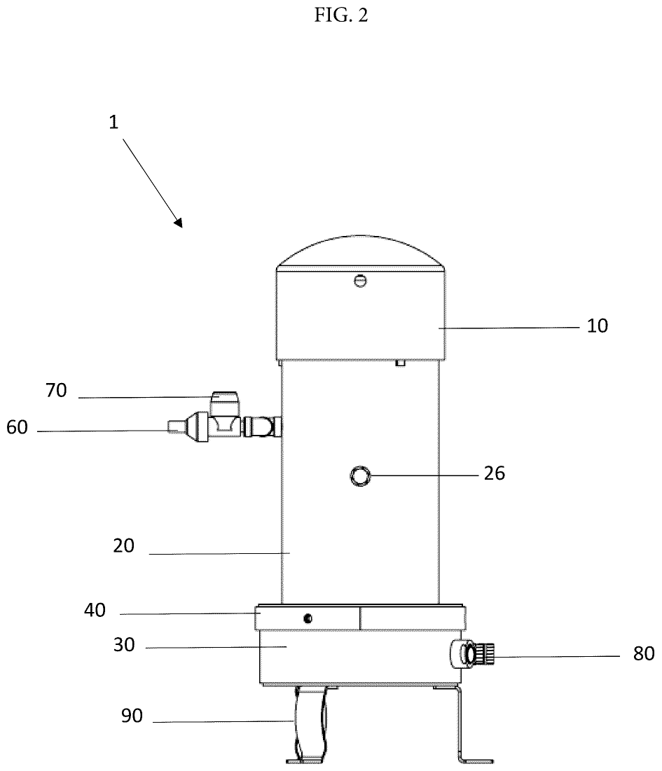

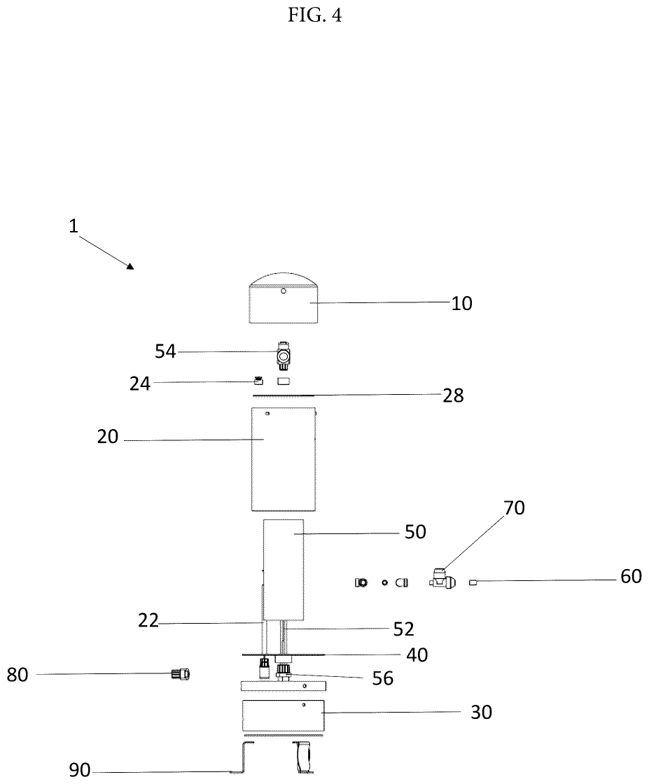

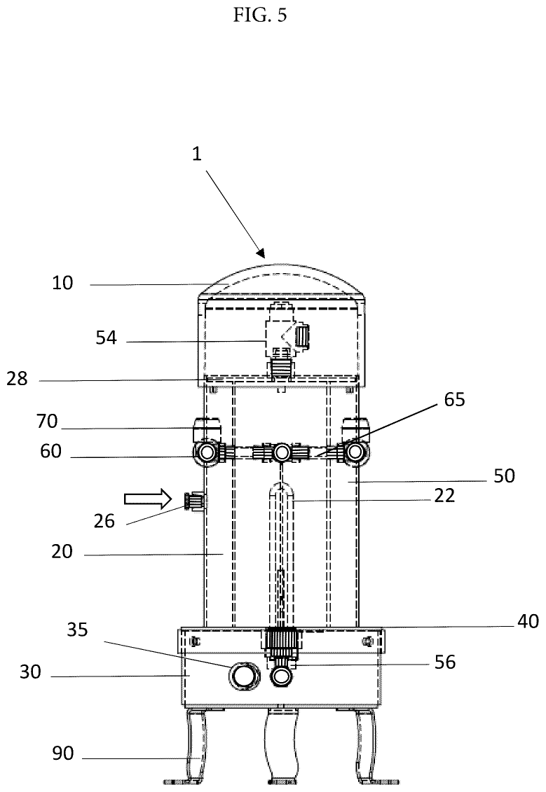

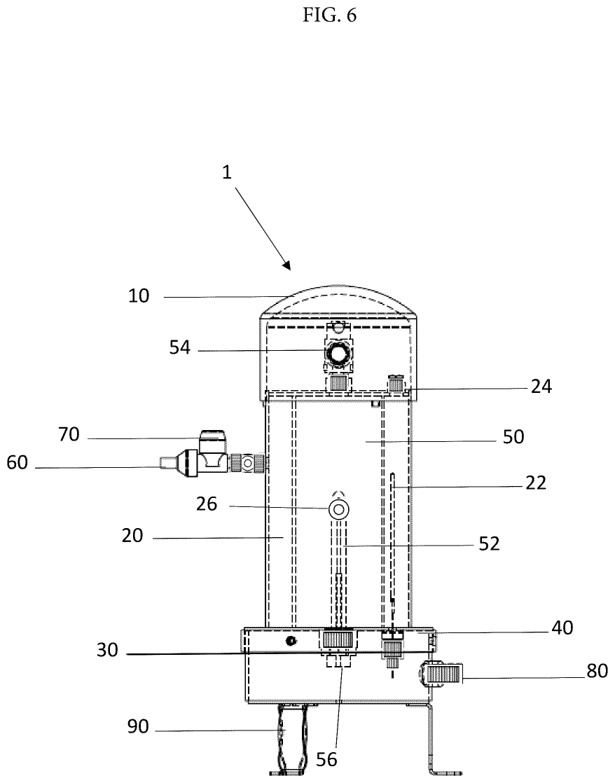

As shown in FIG. 1, the applicator box 1 of the heated wheel and tire applicator system is positioned “on the line” in an automatic car wash to allow the spray nozzles 60 to spray heated cleaning solution at the point of application and appropriate height onto the wheels and tires of a vehicle. As the vehicle is pulled through the car wash, the vehicle may contact a conventional trigger device, not shown, that activates the heated wheel and tire applicator system to spray heated cleaning solution onto the wheels and tires of the vehicle passing by the applicator box 1. The heated wheel and tire applicator system may be comprised of two systems, namely, a circulating heating system and a cleaning solution supply system, which interface in the applicator box 1, the specific parts of which are illustrated in FIGS. 2-6. The heated wheel and tire applicator system may be comprised of a single system, namely, a cleaning solution supply system, which interface in the applicator box 1, the specific parts of which are illustrated in FIGS. 1-7. The cleaning solution supply system provides cleaning solution to the applicator box 1 and may include the application process, and the circulating heating system provides the heat for the cleaning solution in the applicator box 1 at the point of application.

As shown in FIGS. 2-6, the vehicle wheel and tire cleaning apparatus for use in an automatic car wash line comprises an applicator box 1 comprised of an outer compartment 20 and an inner compartment 50. The outer compartment 20 defines an open space containing a cleaning solution supply and is connected to a cleaning solution supply piping 26 and a control flow valve. The inner compartment 50 defines a heat transfer tank or heat exchange compartment. However, in an alternate embodiment the outer compartment 20 may define the heat transfer tank and the inner compartment 50 may be an open space containing a cleaning solution supply. In an alternate embodiment, the supply piping 26 and control flow valve would connect to the inner compartment 50. The applicator box 1 may include a top cover 10 and legs 90.

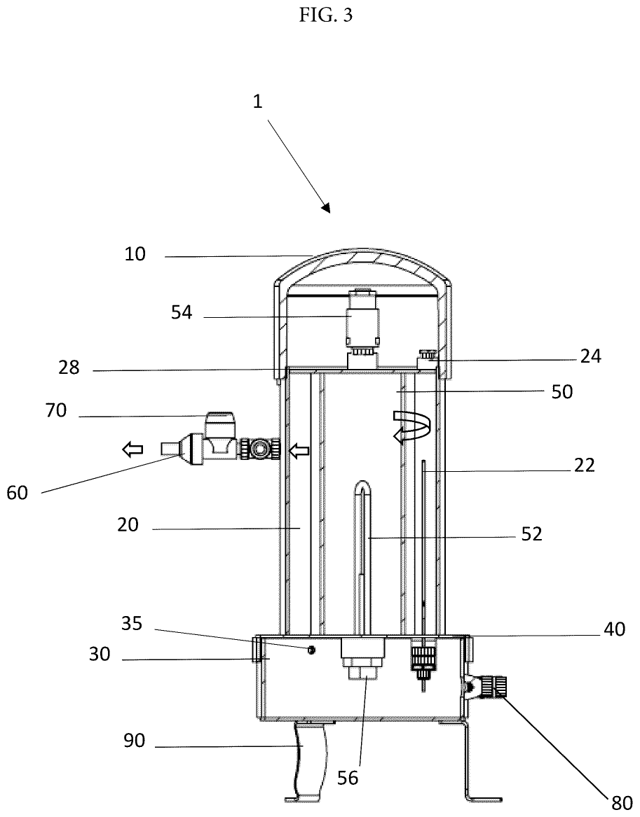

The outer compartment 20 may be comprised of a vessel which may hold the cleaning solution, a cleaning solution inflow piping 26, a pump, an inflow coupling, an outflow coupling, and an outflow pipe as shown in FIGS. 3-5. The outer compartment 20 or lower compartment 30 may be connected with conventional temperature sensors and thermostat controls. Alternatively, the outer compartment 20 or lower compartment 30 may include a wire probe temperature sensor and a clip fastener to releasably couple the probe. The location of the wire probe may be adjustable, but is primarily located to monitor the temperature of the cleaning solution. The location of the wire probe advantageously allows for a more accurate temperature reading by being adjustable and relocatable. A clip fastener may hold the wire probe in a desired location. Lower compartment 30 may also have a port 35 for additional electronic wires, components, and connections. The cleaning solution may be pumped by the pump which is in line with the inflow piping 26 from a cleaning solution supply source through the inflow piping 26 into the outer compartment 20 and then discharged out of the outer compartment 20 through the outflow pipe. The cleaning solution may circulate, rotate, travel, or flow by any means through the outer compartment 20 as illustrated by exemplary arrows in FIG. 3. The outer compartment 20 may have a lid or top plate 28. The outer compartment 20 and flow system may be sealed and self-contained. The cleaning supply solution system may be a flow-regulated, pressurized system. The applicator box 1 may be located in a car wash so that when a vehicle passes the applicator box 1, cleaning solution is sprayed onto the wheels and tires of the vehicle. The cleaning solution may be sprayed onto any part of the vehicle.

At least one thermocouple 22 may be located in the outer compartment 20 to monitor the temperature of the cleaning solution. The at least one thermocouple 22 may extend upwards along a vertical axis of the outer compartment 20. The at least one thermocouple 22 may be connected to a heating element plate 40. By having the at least one thermal couple 22 being connected to the heating element plate 40, the thermal couple 22 may advantageously monitor the temperature of the heat element plate 40 and the cleaning solution in tandem. This advantageously allows for the monitoring of the temperature in multiple locations to provide a more accurate overall temperature reading disparity. The heating element plate 40 may be located between any of the bottom of outer compartment 20 and inner compartment 50 and the lower compartment 30. The at least one thermocouple 22 may extend in an upward direction and be connected at any location between the surface of the outer compartment 20 and the surface of the inner compartment 50. The at least one thermocouple 22 is preferably located an equal distance from the surface of the outer compartment 20 and the surface of the inner compartment 50, but may be located in any position to accurately monitor the temperature of the cleaning solution. By having the at least one thermocouple 22 located at a calculated distance from the surface of the inner compartment 50 and the surface of the outer compartment 20, the temperature monitoring is advantageously more accurate. As heat travels radially outward from a heat source, the temperature of the cleaning solution will vary radially outward. By having the thermocouple 22 or probe location being adjustable, the temperature reading of the cleaning solution may be done in multiple locations to find the most accurate temperature reading location within the outer compartment 20.

The inner compartment 50 may be comprised of a vessel which may hold the heating solution, a heating solution in flow piping 56, a pump, and inflow coupling, and outflow coupling, and an outflow pipe as shown in FIG. 3. The inner compartment 50 may be connected with a conventional temperature or heat transfer device, or heater 52. The heating solution may be pumped by the pump which is in line with the inflow piping 56 from the heating solution supply source through the inflow piping 56 into the inner compartment 50. The heating solution may be in a static state or circulate, rotate, travel, by any flow means within the inner compartment 50. The heating solution may be any liquid or fluid that is commonly used for heat transfer devices such as glycerin. The inner compartment 50 and flow system may sealed and self-contained. The inner compartment and flow system may be a flow regulated, pressurized system and may include a pressure release valve 54 attached to the top plate 28. The heating solution contacts the heater 52 and is thus increased in temperature. The heater 52 may be connected to the heat element plate 40. The heater 52 may extend upwards parallel with the surface of the outer compartment 20 and the surface of the inner compartment 50. The heater 52 may extend upwards toward the cover 10 and parallel with the thermal couple 22. The heater 52 may be located in the center of the inner compartment 50, but may be located elsewhere.

In an alternative embodiment, there may be no inner compartment 50. The heater 52 may be within the outer compartment 20. By having no inner compartment 50, the total volume of the outer compartment 20 is increased. This advantageously allows for more cleaning solution supply to be in the outer compartment 20.

A temperature controller, not shown here, may be located locally or remotely. The temperature controller controls and maintains the temperature of the heating liquid, which controls and maintains the temperature of the cleaning solution. The temperature controller may be operated by a user or automatically updated based on the last temperature reading. The temperature controller may be connected to the heating element plate 40 with a wired connection, or with a wireless connection. The wired connection or wire probe may connect to the heating element plate 40 by passing through the lower compartment 30 and coupling 80.

The cleaning solution supply passes through the outer compartment 20. The cleaning solution supply piping 26 has at least one spray nozzle 60 at the end, but preferably two, connected on one end and on the other end a cleaning solution supply tank, all in fluid communication. The cleaning solution supply piping 26 may include check valve 70. The check valve 70 may act as a flow control valve and control the flow of fluids through the applicator. The check valve 70 may include a spring which fits in the nozzle body that rests on the diaphragm that will only open with an increased pressure from the pump station. Typical car wash check valve springs operate with 20 PSI, however this car wash check valve spring operates at a pressure greater than 20 PSI. This advantageously causes a better penetration of the cleaning solution and results in a cleaner surface, while limiting debris and other unwanted materials from entering the valve. A reduction of debris not only prevents unwanted cleaning results, but increases the life span of the applicator and reduces the amount of internal cleaning and operations. The cleaning solution supply piping 26 may include a bifurcated pipe 65 and at least two spray nozzles 60 having an inline air diaphragm pump placed between the outer compartment 20 and the check valve 70. The check valve 70 may include bidirectional flow or unidirectional flow.

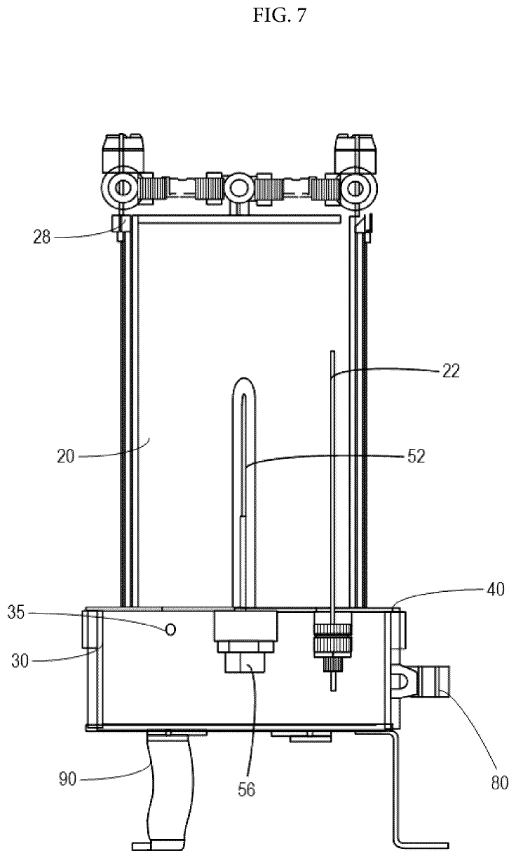

Air and gasses potentially can be trapped in the supply piping 26 or system when the cleaning solution supply source fails. In the event of such a failure, a dilution of chemicals in the cleaning solution supply source or mixing station may occur. This may cause the cleaning solution to drain back into the cleaning solution supply source through the suction tube that feeds the air diaphragm pump including air or gasses to enter the cleaning solution supply source. When the applicator box 1 signals for the cleaning solution supply to be sent through the supply piping 26 during a failure, air or gasses are sent initially which causes an inconsistent solution to be sprayed from the spray nozzle 60. The spray nozzle 60 may also be located at the top end of the outer compartment 20 or top cover 10. The cleaning solution supply piping 26 may extend the spray nozzle 60 through the top cover 10 to advantageously prevent gasses or air to be trapped in the supply piping 26 during a potential equipment failure of the cleaning solution supply source. In an alternative embodiment as shown in FIG. 7, there may be no pressure release valve 54. The excess pressure due to overheating may escape through a spray nozzle 60 at a reduced pressure. This is advantageously safer as the excess pressure is released at a reduced pressure and via the spray nozzle 60. In such an embodiment, the top cover 10 or top plate 28 may be removed or shaped to allow for the spray nozzle 60 to be located at the top end of the outer compartment 20.

The trigger device, not shown, may be placed in a location in the automatic car wash to allow tires of a passing vehicle to contact the trigger device. The trigger device may be a first rubber hose and a second rubber hose that lie approximately three feet apart perpendicular to the forward directional movement of a vehicle being pulled by a conveyor through the car wash. The two rubber hoses are connected to an air Switch that activates and deactivates a 24-Volt power flow from a power source. The trigger device may be any triggering means for communicating to the valve and pump to open or close. The power source may be placed in a remote location and may be connected to a solenoid valve which causes the valve to open and air from the compressor or air source to be sent via the air diaphragm pump and the cleaning solution to the applicators. The power source may be placed in a remote location and may be connected to the temperature controller by wires that pass through a power source inlet in the side wall of the lower compartment 30 of the applicator box 1.

As a vehicle enters an automatic car wash, the vehicle is connected to a conveyor system that pulls the car through the car wash. At which time, the closed check valve 70 or flow control valve prevents the pressurized flow of cleaning solution to the distal flow end and the spray nozzles 60 of the cleaning solution supply pipe 26. As the vehicle is pulled through the car wash, the tires of the vehicle contact the first rubber hose, thereby generating a pulse of air, which travels to an air switch. The pulse of air contacts the normally open contact in the air switch, closing the contact. The closed contact sends a power impulse to the main car wash controller where the wheel and tire relay power outflow is located. When the wheel and tire relay is energized by the power impulse from the air switch, 24-Volt AC power is sent to the temperature controller. This is to send power to a solenoid valve on the air pump to pull the cleaning solution out of the mixing station and further sending the solution out to the wheel and tire applicators. The 24-Volt AC power opens the check valve 70 to allow the flow of the pressurized cleaning solution through the check valve 70 and cleaning solution supply piping 26. Alternatively, the cleaning solution pressurized via the pump, opens the check valve 70. The cleaning solution then flows to the distal flow end and spray nozzles 60 of the cleaning solution supply system, and onto the wheels and tires of a vehicle. The vehicle runs over the second rubber hose, sending an air pulse to open the closed contact in the air switch. When the contact is opened, another power impulse is sent to the main car wash controller to stop the 24-Volt AC power flow to the check valve 70 and cleaning solution supply piping 26. This, in turn, closes the check valve 70, thereby stopping the flow of the cleaning solution through the cleaning solution supply system. Cleaning solution which remains in distal end of supply piping 26 is then heated in the outer compartment 20 for application to the next vehicle coming through the line.

The present invention advantageously provides an apparatus and method for cleaning the wheels and tires on a vehicle in an automatic car wash by heating the solution at the point of application and then spraying heated cleaning solution onto the wheels and tires of the vehicle. Advantageously, the temperature monitoring and adjusting features are more accurate due to the construction and design of the applicator box 1.

The cleaning solution is heated to temperatures between 120° F. to 140° F. inclusive, preferably between 120° F. to 130° F., and most preferred at 125° F. Significantly improved cleaning results have been observed by the use of a prototype applicator. In addition to the improved results, heating the solution allows for use of a less concentrated cleaning solution mixture for effective results, thereby decreasing money spent in operating the system. The cleaning solution is a mixture of water to concentrated cleaner in concentrations of 8:1 to 15:1, preferably at 10:1. Finally, the components of the heated wheel/tire applicator system are preferably comprised of stainless steel and other rust-proof materials that are commercially available.

Although the invention has been described with reference to this preferred embodiment, other embodiments can achieve the same result. Variations and modifications of the present invention will be apparent to those skilled in the art, and the following claims are intended to cover all such modifications and equivalents.

The invention claimed is:

1. A vehicle wheel and tire cleaning apparatus for use in an automatic car wash line, comprising:
an applicator box comprised of an outer compartment, the outer compartment defining an open space containing cleaning solution supply and connected to a cleaning solution supply piping;
the cleaning solution supply passing through the outer compartment;
the cleaning solution supply piping having at least one spray nozzle connected thereto, wherein the cleaning solution supply piping has connected thereto a cleaning solution tank, a check valve, a bifurcated pipe and at least two spray nozzles, with an inline air diaphragm pump placed between the outer compartment and the check valve; and the applicator box being positionable on the automatic car wash line.

2. The vehicle wheel and tire cleaning apparatus of claim 1, further comprising a hot water tank connected thereto a hot water inflow pipe with an inline water pump, and a water outflow pipe, with a hot water source connected in circuit with the inflow pipe and the outflow pipe.

3. The vehicle wheel and tire cleaning apparatus of claim 2, wherein at least a portion of the cleaning solution, just upstream of the at least one spray nozzle, passes between the inner tube and outer tube.

4. The vehicle wheel and tire cleaning apparatus of claim 1, further comprising a triggering mechanism for opening and closing the check valve.

5. The vehicle wheel and tire cleaning apparatus of claim 1, wherein the check valve is configured to cause fluid to travel in one direction.

6. The vehicle wheel and tire cleaning apparatus of claim 1, wherein the at least two spray nozzles are located at the top of the applicator box.

7. A tire and wheel applicator for use on an automatic car wash line, comprising: an applicator box;
a mixing system comprised of:
a hot water source, piping, a pump and a mixing tank; and
at least one spray nozzle, a solenoid valve with triggering device, a diaphragm pump, and cleaning solution source;
at least one distal end of the piping in the mixing system being positioned in the mixing tank; and
a temperature sensor located within the outer tube and arranged to extend parallel with a heater;
wherein the applicator box defines the mixing tank, and the applicator box is positioned adjacent to the spray nozzles, on the automatic car wash line.

8. The vehicle wheel and tire cleaning apparatus of claim 8, wherein the mixing tank is connected thereto a hot water inflow pipe with an inline water pump, and a water outflow pipe, with a hot water source connected in circuit with the inflow pipe and the outflow pipe.

9. The vehicle wheel and tire cleaning apparatus of claim 8, wherein the temperature sensor is arranged to extend from a heating element plate.

10. The vehicle wheel and tire cleaning apparatus of claim 9, wherein a portion of the cleaning solution supply piping, just upstream of the at least one spray nozzle, is fluidly connected to the mixing tank.

11. The vehicle wheel and tire cleaning apparatus of claim 8, further comprising a triggering mechanism for opening and closing the check valve.

12. The vehicle wheel and tire cleaning apparatus of claim 8, wherein the check valve is configured to cause fluid to travel in one direction.

13. The vehicle wheel and tire cleaning apparatus of claim 8, further comprising a remote temperature controller.

14. A vehicle wheel and tire cleaning apparatus for use in an automatic car wash line, comprising:
an applicator box comprised of an cleaning solution compartment, the cleaning solution compartment defining an open space containing cleaning solution supply and fluidly connected to a cleaning solution supply piping and a flow control valve and at least one spray nozzle, the at least one spray nozzle located at the top of the applicator box;
a cleaning solution supply passing through the fluidly connected cleaning solution compartment, the cleaning solution supply piping, and the flow control valve; and
a heating element within the applicator box.

15. The vehicle wheel and tire cleaning apparatus of claim 15, wherein the applicator box is positionable on the automatic car wash line.

16. The vehicle wheel and tire cleaning apparatus of claim 15, wherein the at least one spray nozzle is configured to release excess pressure.

17. The vehicle wheel and tire cleaning apparatus of claim 15, further comprising a temperature sensor arranged to extend from a heating element plate parallel with the heating element.

18. The vehicle wheel and tire cleaning apparatus of claim 15, further comprising a triggering mechanism for opening and closing the flow control valve.

19. The vehicle wheel and tire cleaning apparatus of claim 15, further comprising a remote temperature controller.

20. The vehicle wheel and tire cleaning apparatus of claim 17, wherein the temperature sensor is located within the cleaning solution compartment and in proximity to a heat exchanger.
